(19) United States
(12) Patent Application Publication
(10) Pub. No.: US 2026/0286248 A1
(43) Pub. Date: Sep. 24, 2026

(54) METHOD OF FORMULATING LAUNDRY DETERGENT FOR LOW TEMPERATURE DETERGENCY STABILITY

(71) Applicant: Dow Global Technologies LLC, Midland, MI (US)

(72) Inventors: Yang Zhang, Shanghai (CN); Cheng Shen, Shanghai (CN)

(21) Appl. No.: 19/168,490

(22) PCT Filed: Apr. 13, 2023
(86) PCT No.: PCT/CN2023/087980

§ 371 Date: Sep. 24, 2025

(51) Int. Cl. C11D 1/22; C11D 1/722; C11D 3/20; C11D 3/30; C11D 3/43

(52) U.S. Cl. CPC C11D 1/22; C11D 1/722; C11D 3/2079; C11D 3/30; C11D 3/43; C11D 2111/12

(57) ABSTRACT

A method of formulating a laundry detergent is provided, comprising: (a) selecting an anionic surfactant; (b) selecting a nonionic surfactant, wherein the nonionic surfactant is selected from the group of nonionic surfactants having formula (I) R¹—O-(EO)ₓ-(AO)_{y}-(EO)_{z}—H wherein R¹ a is a linear C₈₋₁₈ alkyl group; wherein x is 2 to 4; wherein AO is an oxyalkylene group with 3 to 5 carbon atoms; wherein y is 6 to 25; wherein z is 1 to 50; and wherein the nonionic surfactant is selected based on its ability to impart detergency stability to the laundry detergent formulation for cleaning water temperatures ranging from 10 to 30° C.; (c) selecting a water miscible organic solvent; and combining the selected anionic surfactant, the selected nonionic surfactant, the selected water miscible organic solvent and water to provide the formulated laundry detergent formulation.

The present invention is related to a method of formulating a laundry detergent formulation to have detergency stability for cleaning water temperatures ranging from 10 to 30° C. In particular, the present invention relates to a method of formulating a laundry detergent formulation to have detergency stability for cleaning water temperatures ranging from 10 to 30° C., comprising: (a) selecting an anionic surfactant, wherein the anionic surfactant is selected from the group consisting of alkyl sulfates, alkyl benzene sulfates, alkyl benzene sulfonic acids, alkyl benzene sulfonates, alkyl polyethoxy sulfates, paraffin sulfonic acids, paraffin sulfonates, olefin sulfonic acids, olefin sulfonates, alpha-sulfocarboxylates, esters of alpha-sulfocarboxylates, alkyl glyceryl ether sulfonic acids, alkyl glyceryl ether sulfonates, sulfates of fatty acids, sulfonates of fatty acids, sulfonates of fatty acid esters, alkyl phenol polyethoxy ether sulfates, 2-acryloxy-alkane-1-sulfonic acids, 2-acryloxy-alkane-1-sulfonates, beta-alkyloxy alkane sulfonic acids, beta-alkyloxy alkane sulfonates, oleic acid, salts thereof and mixtures thereof; (b) selecting a nonionic surfactant, wherein the nonionic surfactant is selected from the group of nonionic surfactants having formula (I)

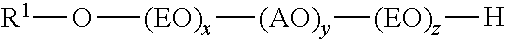

wherein R¹ is a linear C₈₋₁₈ alkyl group; wherein x is 2 to 4; wherein AO is an oxyalkylene group with 3 to 5 carbon atoms; wherein y is 6 to 25; wherein z is 1 to 50; and wherein the nonionic surfactant is selected based on its ability to impart detergency stability to the laundry detergent formulation for cleaning water temperatures ranging from 10 to 30° C.; (c) selecting a water miscible organic solvent, wherein the water miscible organic solvent is selected from the group consisting of C₁₋₄ alcohol with one hydroxyl group; propylene glycol; glycerol; 1,3-butanediol; 1,3-hexanediol; dipropylene glycol and mixtures thereof; and combining the selected anionic surfactant, the selected nonionic surfactant, the selected water miscible organic solvent and water to provide the formulated laundry detergent formulation.

The efficiency of fabric cleaning is dependent on the wash liquid temperature. Lowering of the wash liquid temperature usually leads to poorer soil removal. However, cleaning fabric articles under low temperature conditions is inevitable during the winter months in many geographic regions. That is, many consumers do not have a hot water supply in their houses and municipal water supplies can sometimes be at temperatures of 10° C. when fed into washing machines. In addition, consumers are increasingly choosing to do laundry without heating to reduce energy consumption and carbon emissions. Notwithstanding the temperature of the wash water, consumers expect their laundry detergent to perform consistently.

Accordingly, there is a continuing need for laundry detergent formulations that exhibit detergency stability for cleaning water temperatures from 10 to 30° C.

The present invention provides a method of formulating a laundry detergent formulation to have detergency stability for cleaning water temperatures ranging from 10 to 30° C., comprising: (a) selecting an anionic surfactant, wherein the anionic surfactant is selected from the group consisting of alkyl sulfates, alkyl benzene sulfates, alkyl benzene sulfonic acids, alkyl benzene sulfonates, alkyl polyethoxy sulfates, paraffin sulfonic acids, paraffin sulfonates, olefin sulfonic acids, olefin sulfonates, alpha-sulfocarboxylates, esters of alpha-sulfocarboxylates, alkyl glyceryl ether sulfonic acids, alkyl glyceryl ether sulfonates, sulfates of fatty acids, sulfonates of fatty acids, sulfonates of fatty acid esters, alkyl phenol polyethoxy ether sulfates, 2-acryloxy-alkane-1-sulfonic acids, 2-acryloxy-alkane-1-sulfonates, beta-alkyloxy alkane sulfonic acids, beta-alkyloxy alkane sulfonates, oleic acid, salts thereof and mixtures thereof; (b) selecting a nonionic surfactant, wherein the nonionic surfactant is selected from the group of nonionic surfactants having formula (I)

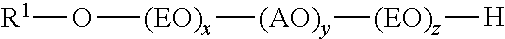

wherein R¹ is a linear C₈₋₁₈ alkyl group; wherein AO is an oxyalkylene group with 3 to 5 carbon atoms; wherein x is 2 to 4; wherein y is 6 to 25; wherein z is 1 to 50; and wherein the nonionic surfactant is selected based on its ability to impart detergency stability to the laundry detergent formulation for cleaning water temperatures ranging from 10 to 30° C.; (c) selecting a water miscible organic solvent, wherein the water miscible organic solvent is selected from the group consisting of C₁₋₄ alcohol with one hydroxyl group; propylene glycol; glycerol; 1,3-butanediol; 1,3-hexanediol; dipropylene glycol and mixtures thereof; and combining the selected anionic surfactant, the selected nonionic surfactant, the selected water miscible organic solvent and water to provide the formulated laundry detergent formulation.

The present invention also provides a method of formulating a laundry detergent formulation to have detergency stability for cleaning water temperatures ranging from 10 to 30° C. comprising: (a) selecting an anionic surfactant, wherein the anionic surfactant is selected from the group consisting of alkyl sulfates, alkyl benzene sulfates, alkyl benzene sulfonic acids, alkyl benzene sulfonates, alkyl polyethoxy sulfates, paraffin sulfonic acids, paraffin sulfonates, olefin sulfonic acids, olefin sulfonates, alpha-sulfocarboxylates, esters of alpha-sulfocarboxylates, alkyl glyceryl ether sulfonic acids, alkyl glyceryl ether sulfonates, sulfates of fatty acids, sulfonates of fatty acids, sulfonates of fatty acid esters, alkyl phenol polyethoxy ether sulfates, 2-acryloxy-alkane-1-sulfonic acids, 2-acryloxy-alkane-1-sulfonates, beta-alkyloxy alkane sulfonic acids, beta-alkyloxy alkane sulfonates, oleic acid, salts thereof and mixtures thereof; (b) selecting a nonionic surfactant, wherein the nonionic surfactant is selected from the group of nonionic surfactants having formula (I); wherein R¹ is a linear C₈₋₁₈ alkyl group; wherein AO is an oxyalkylene group with 3 carbon atoms; wherein x is 2 to 4; wherein v is 6 to 25; wherein z is 1 to 50; and wherein the nonionic surfactant is selected based on its ability to impart detergency stability to the laundry detergent formulation for cleaning water temperatures ranging from 10 to 30° C.; (c) selecting a water miscible organic solvent, wherein the water miscible organic solvent is selected from the group consisting of C₁₋₄ alcohol with one hydroxyl group; propylene glycol; glycerol; 1,3-butanediol; 1,3-hexanediol; dipropylene glycol and mixtures thereof; and combining the selected anionic surfactant, the selected nonionic surfactant, the selected water miscible organic solvent and water to provide the formulated laundry detergent formulation; wherein the formulated laundry detergent formulation comprises 5 to 95 wt %, based on weight of the formulated laundry detergent formulation, of the selected anionic surfactant (a) plus the selected nonionic surfactant (b).

The present invention also provides a method of formulating a laundry detergent formulation to have detergency stability for cleaning water temperatures ranging from 10 to 30° C., comprising: (a) selecting an anionic surfactant, wherein the anionic surfactant is selected from the group consisting of alkyl sulfates, alkyl benzene sulfates, alkyl benzene sulfonic acids, alkyl benzene sulfonates, alkyl polyethoxy sulfates, paraffin sulfonic acids, paraffin sulfonates, olefin sulfonic acids, olefin sulfonates, alpha-sulfocarboxylates, esters of alpha-sulfocarboxylates, alkyl glyceryl ether sulfonic acids, alkyl glyceryl ether sulfonates, sulfates of fatty acids, sulfonates of fatty acids, sulfonates of fatty acid esters, alkyl phenol polyethoxy ether sulfates, 2-acryloxy-alkane-1-sulfonic acids, 2-acryloxy-alkane-1-sulfonates, beta-alkyloxy alkane sulfonic acids, beta-alkyloxy alkane sulfonates, oleic acid, salts thereof and mixtures thereof; (b) selecting a nonionic surfactant, wherein the nonionic surfactant is selected from the group of nonionic surfactants having formula (I); wherein R¹ is a linear C₈₋₁₈ alkyl group; wherein AO is an oxyalkylene group with 3 atoms; wherein x is 2 to 4; wherein y is 6 to 25; wherein z is 1 to 50; and wherein the nonionic surfactant is selected based on its ability to impart detergency stability to the laundry detergent formulation for cleaning water temperatures ranging from 10 to 30° C.; (c) selecting a water miscible organic solvent, wherein the water miscible organic solvent is selected from the group consisting of C₁₋₄ alcohol with one hydroxyl group; propylene glycol; glycerol; 1,3-butanediol; 1,3-hexanediol; dipropylene glycol and mixtures thereof; and combining the selected anionic surfactant, the selected nonionic surfactant, the selected water miscible organic solvent and water to provide the formulated laundry detergent formulation; wherein the formulated laundry detergent formulation comprises 5 to 95 wt %, based on weight of the formulated laundry detergent formulation, of the selected anionic surfactant (a) plus the selected nonionic surfactant (b); wherein the selected nonionic surfactant (b) comprises 15 to 60 wt % of the combination of the selected anionic surfactant (a) plus the selected nonionic surfactant (b).

The present invention also provides a method of formulating a laundry detergent formulation to have detergency stability for cleaning water temperatures ranging from 10 to 30° C. comprising: (a) selecting an anionic surfactant, wherein the anionic surfactant is selected from the group consisting of alkyl sulfates, alkyl benzene sulfates, alkyl benzene sulfonic acids, alkyl benzene sulfonates, alkyl polyethoxy sulfates, paraffin sulfonic acids, paraffin sulfonates, olefin sulfonic acids, olefin sulfonates, alpha-sulfocarboxylates, esters of alpha-sulfocarboxylates, alkyl glyceryl ether sulfonic acids, alkyl glyceryl ether sulfonates, sulfates of fatty acids, sulfonates of fatty acids, sulfonates of fatty acid esters, alkyl phenol polyethoxy ether sulfates, 2-acryloxy-alkane-1-sulfonic acids, 2-acryloxy-alkane-1-sulfonates, beta-alkyloxy alkane sulfonic acids, beta-alkyloxy alkane sulfonates, oleic acid, salts thereof and mixtures thereof; (b) selecting a nonionic surfactant, wherein the nonionic surfactant is selected from the group of nonionic surfactants having formula (I); wherein R¹ is a linear C₈₋₁₈ alkyl group; wherein AO is an oxyalkylene group with 3 carbon atoms; wherein x is 2 to 4; wherein y is 6 to 25; wherein z is 1 to 50; and wherein the nonionic surfactant is selected based on its ability to impart detergency stability to the laundry detergent formulation for cleaning water temperatures ranging from 10 to 30° C.; (c) selecting a water miscible organic solvent, wherein the water miscible organic solvent is selected from the group consisting of C₁₋₄ alcohol with one hydroxyl group; propylene glycol; glycerol; 1,3-butanediol; 1,3-hexanediol; dipropylene glycol and mixtures thereof; and combining the selected anionic surfactant, the selected nonionic surfactant, the selected water miscible organic solvent and water to provide the formulated laundry detergent formulation; wherein the formulated laundry detergent formulation comprises 5 to 95 wt %, based on weight of the formulated laundry detergent formulation, of the selected anionic surfactant (a) plus the selected nonionic surfactant (b); wherein the selected nonionic surfactant (b) comprises 15 to 60 wt % of the combination of the selected anionic surfactant (a) plus the selected nonionic surfactant (b); wherein the formulated laundry detergent formulation comprises 5 to 40 wt %, based on weight of the formulated laundry detergent formulation, of the water miscible organic solvent.

The present invention also provides use of a surfactant blend to impart low temperature detergency stability to a laundry detergent formulation, wherein the surfactant blend comprises: (a) an anionic surfactant is selected from the group consisting of alkyl sulfates, alkyl benzene sulfates, alkyl benzene sulfonic acids, alkyl benzene sulfonates, alkyl polyethoxy sulfates, paraffin sulfonic acids, paraffin sulfonates, olefin sulfonic acids, olefin sulfonates, alpha-sulfocarboxylates, esters of alpha-sulfocarboxylates, alkyl glyceryl ether sulfonic acids, alkyl glyceryl ether sulfonates, sulfates of fatty acids, sulfonates of fatty acids, sulfonates of fatty acid esters, alkyl phenol polyethoxy ether sulfates, 2-acryloxy-alkane-1-sulfonic acids, 2-acryloxy-alkane-1-sulfonates, beta-alkyloxy alkane sulfonic acids, beta-alkyloxy alkane sulfonates, oleic acid, salts thereof and mixtures thereof; and (b) a nonionic surfactant, wherein the nonionic surfactant is selected from the group of nonionic surfactants having formula (I); wherein R¹ is a linear C₈₋₁₈ alkyl group; wherein AO is an oxyalkylene group with 3 to 5 carbon atoms; wherein x is 2 to 4; wherein v is 6 to 25; wherein the low temperature detergency stability is exhibited across washing temperatures of 10 to 30° C.

The present invention also provides a method of washing a fabric article, comprising: providing a soiled fabric article; formulating a laundry detergent formulation according to the method of the present invention; providing a wash water; and applying the wash water and the formulated laundry detergent formulation to the soiled fabric article to provide a cleaned fabric article; wherein the wash water is at a temperature of 10 to 30° C.

### DETAILED DESCRIPTION

It has been surprisingly found that aqueous liquid laundry detergents specifically formulated with a combination of a selection of anionic surfactants, with a nonionic surfactant having formula (I)

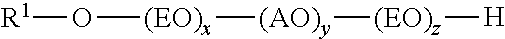

wherein R¹ is a linear C₈₋₁₈ alkyl group (preferably, a linear C₁₀₋₁₈ alkyl group; more preferably, a linear C₁₂₋₁₄ alkyl group or a linear C₁₆₋₁₈ alkyl group); wherein AO is an oxyalkylene group with 3 to 5 carbon atoms (preferably, 3 to 4 carbon atoms; more preferably, 3 carbon atoms); wherein x is 2 to 4 (preferably, 4); wherein y is 6 to 25 (preferably, 7 to 20; more preferably, 8 to 15; most preferably, 8 to 14); wherein z is 1 to 50 (preferably, 4 to 40; more preferably, 6 to 30; most preferably, 8 to 25); exhibit detergency stability for cleaning water temperatures ranging from 10 to 30° C.

Unless otherwise indicated, ratios, percentages, parts, and the like are by weight.

The term “low temperature detergency stability” as used herein and in the appended claims means that the soil removal index (SRI), calculated using ASTM Method D4265-14, for a given laundry detergent formulation at a wash temperature of 10° C. is at least 95% (preferably, at least 97%; more preferably, at least 98%; most preferably, at least 100%) of the soil removal index (SRI), calculated using ASTM Method D4265-14, for the same laundry detergent formulation at a wash temperature of 30° C.

Preferably, the method of formulating a laundry detergent formulation to have detergency stability for cleaning water temperatures ranging from 10 to 30° C., of the present invention, comprises: (a) selecting an anionic surfactant, wherein the anionic surfactant is selected from the group consisting of alkyl sulfates, alkyl benzene sulfates, alkyl benzene sulfonic acids, alkyl benzene sulfonates, alkyl polyethoxy sulfates, paraffin sulfonic acids, paraffin sulfonates, olefin sulfonic acids, olefin sulfonates, alpha-sulfocarboxylates, esters of alpha-sulfocarboxylates, alkyl glyceryl ether sulfonic acids, alkyl glyceryl ether sulfonates, sulfates of fatty acids, sulfonates of fatty acids, sulfonates of fatty acid esters, alkyl phenol polyethoxy ether sulfates, 2-acryloxy-alkane-1-sulfonic acids, 2-acryloxy-alkane-1-sulfonates, beta-alkyloxy alkane sulfonic acids, beta-alkyloxy alkane sulfonates, oleic acid, salts thereof and mixtures thereof (preferably, wherein the anionic surfactant is selected from the group consisting of C₈₋₂₀ alkyl benzene sulfates, C₈₋₂₀ alkyl benzene sulfonic acids, C₈₋₂₀ alkyl benzene sulfonates, C₈₋₂₀ alkyl polyethoxy sulfates, paraffin sulfonic acids, paraffin sulfonates, alpha-olefin sulfonic acids, alpha-olefin sulfonates, sulfonates of fatty acids, sulfonates of fatty acid esters, oleic acid, salts thereof and mixtures thereof; more preferably, wherein the anionic surfactant is selected from the group consisting of C₁₂₋₁₆ alkyl benzene sulfonic acids. C₁₂₋₁₆ alkyl benzene sulfonates. C₁₂-16 alkyl polyethoxy sulfates, C₁₂₋₁₈ paraffin-sulfonic acids, C₁₂₋₁₈ paraffin-sulfonates, oleic acid and mixtures thereof; still more preferably, wherein the anionic surfactant is selected from the group consisting of C₁₂₋₁₆ alkyl benzene sulfonic acids. C₁₂₋₁₆ alkyl benzene sulfonates. C₁₂-16 alkyl polyethoxy sulfates, oleic acid and mixtures thereof; yet more preferably, wherein the anionic surfactant includes a mixture of dodecyl benzene sulfonic acid, sodium laureth-2 sulfate and oleic acid; most preferably, wherein the anionic surfactant is a mixture of dodecyl benzene sulfonic acid, sodium laureth-2 sulfate and oleic acid); (b) selecting a nonionic surfactant, wherein the nonionic surfactant is selected from the group of nonionic surfactants having formula (I)

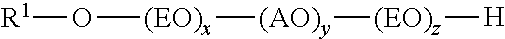

wherein R¹ is a linear C₈₋₁₈ alkyl group (preferably, a linear C₁₀₋₁₈ alkyl group; more preferably, a linear C₁₂₋₁₄ alkyl group or a linear C₁₆₋₁₈ alkyl group); wherein AO is an oxyalkylene group with 3 to 5 carbon atoms (preferably, 3 to 4 carbon atoms; more preferably, 3 carbon atoms); wherein x is 2 to 4 (preferably, 4); wherein y is 6 to 25 (preferably, 7 to 20: more preferably, 8 to 15; most preferably, 8 to 14); wherein z is 1 to 50 (preferably, 4 to 40; more preferably, 6 to 30; most preferably, 8 to 25); and wherein the nonionic surfactant is selected based on its ability to impart detergency stability to the laundry detergent formulation for cleaning water temperatures ranging from 10 to 30° C.; (c) selecting a water miscible organic solvent, wherein the water miscible organic solvent is selected from the group consisting of C₁₋₄ alcohol with one hydroxyl group (e.g., ethanol); propylene glycol; glycerol; 1,3-butanediol; 1,3-hexanediol; dipropylene glycol and mixtures thereof (preferably, ethanol, propylene glycol and mixtures thereof; more preferably, propylene glycol); and combining the selected anionic surfactant, the selected nonionic surfactant, the selected water miscible organic solvent and water to provide the formulated laundry detergent formulation (preferably, wherein the formulated laundry detergent formulation comprises 5 to 95 wt % (preferably, 25 to 80 wt %; more preferably, 35 to 75 wt %; still more preferably, 45 to 70 wt %; yet more preferably, 50 to 70 wt %; most preferably, 60 to 70 wt %), based on weight of the formulated laundry detergent formulation, of the selected anionic surfactant (a) plus the selected nonionic surfactant (b))(preferably, wherein the selected nonionic surfactant (b) comprises 15 to 60 wt % (preferably, 25 to 60 wt %; more preferably, 35 to 57 wt %; most preferably, 40 to 56 wt %) of the combination of the selected anionic surfactant (a) plus the selected nonionic surfactant (b))(preferably, wherein the formulated laundry detergent formulation comprises 5 to 40 wt % (preferably, 20 to 40 wt %; more preferably, 20 to 35 wt %; still more preferably, 20 to 30 wt %; most preferably, 20 to 25 wt %), based on weight of the formulated laundry detergent formulation, of the water miscible organic solvent).

Preferably, the method of formulating a laundry detergent formulation to have detergency stability for cleaning water temperatures ranging from 10 to 30° C., of the present invention, further comprises selecting an optional additive for incorporating into the formulated laundry detergent formulation. More preferably, the method of formulating a laundry detergent formulation to have detergency stability for cleaning water temperatures ranging from 10 to 30° C., of the present invention, further comprises selecting an optional additive for incorporating into the formulated laundry detergent formulation; wherein the optional additive is selected from the group consisting of builders (e.g., sodium bicarbonate, sodium carbonate, zeolites, sodium citrate, sodium tripolyphosphate and aminocarboxylates (such as methylglycine diacetic acid, sodium salt or glutamic acid diacetic acid, sodium salt)); hydrotropes (e.g., sodium xylene sulfonate, sodium cumene sulfonate, sodium toluene sulfonate); foam control agents (e.g., polydimethylsiloxane); enzymes (e.g., protease, cellulases, lipase, amylase, mannanases); preservatives; fragrances (e.g., essential oils such as D-limonene); fluorescent whitening agents; bleach (e.g., sodium percarbonate, sodium perborate, sodium hypochlorite); dyes; additive polymers (e.g., dispersant polymers such as acrylic acid homopolymers and copolymers of acrylic acid with maleic acid, sulfonated monomer and/or ethyl acrylate); fabric softeners (e.g., softening silicones, cationic coacervating polymers (e.g., cationic hydroxyalkyl cellulose, polyquaternium polymers)); pH adjusters/buffers; additional surfactants (e.g., cationic surfactants, amphoteric surfactants); cleaning boosters and mixtures thereof.

Preferably, the use of a surfactant blend to impart low temperature detergent stability to a laundry detergent formulation, wherein the surfactant blend of the present invention comprises: (a) an anionic surfactant is selected from the group consisting of alkyl sulfates, alkyl benzene sulfates, alkyl benzene sulfonic acids, alkyl benzene sulfonates, alkyl polyethoxy sulfates, paraffin sulfonic acids, paraffin sulfonates, olefin sulfonic acids, olefin sulfonates, alpha-sulfocarboxylates, esters of alpha-sulfocarboxylates, alkyl glyceryl ether sulfonic acids, alkyl glyceryl ether sulfonates, sulfates of fatty acids, sulfonates of fatty acids, sulfonates of fatty acid esters, alkyl phenol polyethoxy ether sulfates, 2-acryloxy-alkane-1-sulfonic acids, 2-acryloxy-alkane-1-sulfonates, beta-alkyloxy alkane sulfonic acids, beta-alkyloxy alkane sulfonates, oleic acid, salts thereof and mixtures thereof (preferably, wherein the anionic surfactant is selected from the group consisting of C₈₋₂₀ alkyl benzene sulfates, C₈₋₂₀ alkyl benzene sulfonic acids, C₈₋₂₀ alkyl benzene sulfonates, C₈₋₂₀ alkyl polyethoxy sulfates, paraffin sulfonic acids, paraffin sulfonates, alpha-olefin sulfonic acids, alpha-olefin sulfonates, sulfonates of fatty acids, sulfonates of fatty acid esters, oleic acid, salts thereof and mixtures thereof; more preferably, wherein the anionic surfactant is selected from the group consisting of C₁₂₋₁₆ alkyl benzene sulfonic acids, C₁₂₋₁₆ alkyl benzene sulfonates, C₁₂₋₁₆ alkyl polyethoxy sulfates, C₁₂₋₁₈ paraffin-sulfonic acids, C₁₂₋₁₈ paraffin-sulfonates, oleic acid and mixtures thereof; still more preferably, wherein the anionic surfactant is selected from the group consisting of C₁₂₋₁₆ alkyl benzene sulfonic acids, C₁₂₋₁₆ alkyl benzene sulfonates, C₁₂-16 alkyl polyethoxy sulfates, oleic acid and mixtures thereof; yet more preferably, wherein the anionic surfactant includes a mixture of dodecyl benzene sulfonic acid, sodium laureth-2 sulfate and oleic acid; most preferably, wherein the anionic surfactant is a mixture of dodecyl benzene sulfonic acid, sodium laureth-2 sulfate and oleic acid); and (b) a nonionic surfactant, wherein the nonionic surfactant is selected from the group of nonionic surfactants having formula (I)

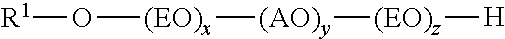

wherein R¹ is a linear C₈₋₁₈ alkyl group (preferably, a linear C₁₀₋₁₈ alkyl group; more preferably, a linear C₁₂₋₁₄ alkyl group or a linear C₁₆₋₁₈ alkyl group); wherein AO is an oxyalkylene group with 3 to 5 carbon atoms (preferably, 3 to 4 carbon atoms; more preferably, 3 carbon atoms); wherein x is 2 to 4 (preferably, 4); wherein y is 6 to 25 (preferably, 7 to 20; more preferably, 8 to 15; most preferably, 8 to 14); wherein the low temperature detergency stability is exhibited across washing temperatures of 10 to 30° C. (preferably, wherein the laundry detergent formulation comprises 5 to 95 wt % (preferably, 25 to 80 wt %; more preferably, 35 to 75 wt %; still more preferably, 45 to 70 wt %; yet more preferably, 50 to 70 wt %; most preferably, 60 to 70 wt %), based on weight of the laundry detergent formulation, of surfactant blend)(preferably, wherein the surfactant blend comprises 15 to 60 wt % (preferably, 25 to 60 wt %; more preferably, 35 to 57 wt %; most preferably, 40 to 56 wt %), based on weight of the surfactant blend, of the nonionic surfactant (b))(preferably, wherein the laundry detergent formulation further comprises 5 to 40 wt % (preferably, 20 to 40 wt %; more preferably, 20 to 35 wt %; still more preferably, 20 to 30 wt %; most preferably, 20 to 25 wt %), based on weight of the laundry detergent formulation, of a water miscible organic solvent).

Preferably, the method of washing a fabric article of the present invention, comprises: providing a soiled fabric article (preferably, wherein the soiled fabric article is soiled with oil and grease borne soil; more preferably, wherein the soiled fabric article is soiled with sebum oils)(preferably, wherein the soiled fabric article is stained cotton fabric; more preferably, wherein the soiled fabric article is stained polycotton fabric); providing a formulated laundry detergent formulation having a detergency stability for cleaning water temperatures ranging from 10 to 30° C. according to the method of the present invention; providing a wash water; and applying the wash water and the formulated laundry detergent formulation to the soiled fabric article to provide a cleaned fabric article; wherein the wash water is at a temperature of 10 to 30° C. More preferably, the method of washing a fabric article of the present invention, comprises: providing a soiled fabric article (preferably, wherein the soiled fabric article is soiled with oil and grease borne soil; more preferably, wherein the soiled fabric article is soiled with sebum oils)(preferably, wherein the soiled fabric article is stained cotton fabric; more preferably, wherein the soiled fabric article is stained polycotton fabric); providing a formulated laundry detergent formulation having a detergency stability for cleaning water temperatures ranging from 10 to 30° C. according to the method of the present invention; providing a wash water; providing a rinse water; applying the wash water and the laundry detergent formulation to the soiled fabric to provide a cleaned fabric article; wherein the wash water is at a temperature of 10 to 30° C.; and then applying the rinse water to the cleaned fabric article to remove the formulated laundry detergent formulation from the cleaned fabric article.

Some embodiments of the present invention will now be described in detail in the following Examples.

### Synthesis S1: L-C₁₆₋₁₈-(EO)₄—(PO)₁₄-(EO)₂₅

A nonionic surfactant represented by the formula L-C₁₆₋₁₈-(EO)₄—(PO)₁₄-(EO)₂₅ was prepared, wherein “L-C₁₆₋₁₈” is a linear C₁₆₋₁₈ is alkyl moiety. One mole of L-C₁₆₋₁₈ alcohol and a 45-50 wt % aqueous solution of potassium hydroxide were charged to a reactor. The potassium hydroxide charge was sufficient to provide a KOH concentration of 0.17 wt %, based on weight of the polymer product. The contents of the reactor were maintained at 50 to 60° C. for thirty minutes. The moisture content in the vapor space of the reactor was then reduced to less than 1,000 ppm by vacuum stripping at 80° C. The temperature set point for the reactor contents was then raised to 110° C. Then four molar equivalents of ethylene oxide. EO, based on the initial charge of L-C₁₆₋₁₈ alcohol, was fed to the reactor slowly while the temperature of the reactor contents was maintained at 110 to 140° C. When the pressure in the reactor returned to approximately the same as the pressure prior to feeding the EO, fourteen molar equivalents of propylene oxide, PO, based on the initial charge of L-C₁₆₋₁₈ alcohol, was fed to the reactor slowly while the temperature of the reactor contents was maintained at 110 to 140° C. When the pressure in the reactor returned to approximately the same as the pressure prior to feeding the PO, five molar equivalents of EO, based on the initial charge of L-C₁₆₋₁₈ alcohol, was fed to the reactor slowly while the temperature of the reactor contents was maintained at 110 to 140° C. When the pressure in the reactor returned to approximately the same pressure as before feeding the EO, the reactor contents were maintained at 110 to 140° C. for two more hours to facilitate full reaction of the EO. The reactor was then purged with nitrogen and the reactor contents were cooled down to 60° C. Then acetic acid was added to the reactor contents to neutralize the potassium hydroxide. After the reactor contents cooled down to 40° C. the product polymer was recovered.

### Syntheses S2-S9

The procedure described in Synthesis S1 was repeated in Syntheses S2-S9 wherein the alcohol used had an alkyl group as noted in TABLE 1 and the relative molar amounts of EQ and PO added in the various steps as noted in TABLE 1.

TABLE 1

| | | Alkylene Oxide | | | |
|---|---|---|---|---|---|
| | | Blocks (mols) | | | |
| | | | | 2^{nd} | |
| | | 1^{st} EO | PO | EO | |
| Ex. | R* | Block | Block | Block | Generic Structure |
| S1 | L-C₁₆₋₁₈ | 4 | 14 | 25 | L-C₁₆₋₁₈-(EO)₄(PO)₁₄(EO)₂₅ |
| S2 | L-C₁₂₋₁₄ | 4 | 8 | 6 | L-C₁₂₋₁₄-(EO)₄(PO)₈(EO)₆ |
| S3 | L-C₁₂₋₁₄ | 4 | 8 | 8 | L-C₁₂₋₁₄-(EO)₄(PO)₈(EO)₈ |
| S4 | L-C₁₂₋₁₄ | 4 | 12 | 8 | L-C₁₂₋₁₄-(EO)₄(PO)₁₂(EO)₈ |
| S5 | L-C₁₂₋₁₄ | 4 | 12 | 14 | L-C₁₂₋₁₄-(EO)₄(PO)₁₂(EO)₁₄ |
| S6 | L-C₁₆₋₁₈ | 4 | 14 | 15 | L-C₁₆₋₁₈-(EO)₄(PO)₁₄(EO)₁₅ |
| S7 | L-C₁₂₋₁₄ | 4 | 8 | 4 | L-C₁₂₋₁₄-(EO)₄(PO)₈(EO)₄ |
| S8 | L-C₁₂₋₁₄ | 9 | 0 | 0 | L-C₁₂₋₁₄-(EO)₉ |
| S9 | S-C₁₂₋₁₄ | 3 | 10 | 10 | S-C₁₂₋₁₄-(EO)₃-(PO)₁₀- |
| | | | | | (EO)₁₀ |
| S10 | B-C₈ | 0 | 5 | 9 | B-C₈-(PO)₅-(EO)₉ |

*L-alkyl group is a linear alcohol (R—OH) wherein R is a linear alkyl group with listed number carbons and the hydroxyl (—OH) group is bound to a primary carbon atom at the end of the alkyl chain.
S-alkyl group is a secondary alcohol (R—OH) wherein R is linear alkyl group with the listed number of carbons and the hydroxyl (—OH) group is bound to a secondary carbon atom along the interior of the alkyl chain.
B-alkyl group is a branched alcohol (R—OH) wherein R is a branched alkyl group with the listed number of carbons and the hydroxyl (—OH) group is bound to a primary carbon atom at the end of a branched alkyl chain.

### Comparative Examples CF1-CF11 and Examples F1-F14: Unit Dose Detergent

The unit dose laundry detergent formulations of Comparative Examples CF1-CF11 and Examples F1-F14 used in the cleaning tests in subsequent Examples were prepared having the formulation as described in TABLES 2-3. The water and propylene glycol were mixed in a beaker with mechanical stirring. The dodecylbenzene sulfonic acid, oleic acid and monoethanol amine were then added in the beaker with continued stirring. The nonionic surfactant (Synthesis S1-S10) was then added to the beaker with continued stirring. The pH was then adjusted to 7.5 with monoethanol amine to form the unit dose laundry detergent.

### Comparative Examples CF12-CF13 and Examples F15-F21: Liquid Laundry Detergent

The liquid laundry detergent formulations of Comparative Examples CF12-CF13 and Examples F15-F21 used in the cleaning tests in subsequent Examples were prepared having the formulation as described in TABLE 4. The water and propylene glycol were mixed in a beaker with mechanical stirring. The dodecylbenzene sulfonic acid, oleic acid and monoethanol amine were then added in the beaker with continued stirring. The nonionic surfactant (Synthesis S1-S6 or Synthesis S9-S10) was then added to the beaker with continued stirring. The pH was then adjusted to 8-8.5 with monoethanol amine to form the concentrated liquid laundry detergent.

TABLE 2

| | Examples (wt %) | | | | | | | | | | | |
|---|---|---|---|---|---|---|---|---|---|---|---|---|
| Ingredient | CF1 | CF2 | CF3 | CF4 | CF5 | CF6 | CF7 | CF8 | F1 | F2 | F3 | F4 |
| Propylene glycol | 23 | 23 | 23 | 23 | 23 | 23 | 23 | 23 | 23 | 23 | 23 | 23 |
| Dodecylbenzene sulfonic acid | 10 | 40 | 20 | 25 | 30 | 35 | 10 | 40 | 20 | 25 | 30 | 35 |
| Monoethanol amine | 3.5 | 9.5 | 5.5 | 6.5 | 7.5 | 8.5 | 3.5 | 9.5 | 5.5 | 6.5 | 7.5 | 8.5 |
| Oleic acid | 10 | 10 | 10 | 10 | 10 | 10 | 10 | 10 | 10 | 10 | 10 | 10 |
| Synthesis S8 | — | — | 31 | 25 | 19 | 13 | 43 | 7 | — | — | — | — |
| Synthesis S1 | 43 | 7 | — | — | — | — | — | — | 31 | 25 | 19 | 13 |
| Deionized water | 10.5 | 10.5 | 10.5 | 10.5 | 10.5 | 10.5 | 10.5 | 10.5 | 10.5 | 10.5 | 10.5 | 10.5 |
| Total wt % surfactants | 66.5 | 66.5 | 66.5 | 66.5 | 66.5 | 66.5 | 66.5 | 66.5 | 66.5 | 66.5 | 66.5 | 66.5 |
| % of surfactants -- nonionic | 64.7 | 10.5 | 46.6 | 37.6 | 28.6 | 19.5 | 64.7 | 10.5 | 46.6 | 37.6 | 28.6 | 19.5 |

TABLE 3

| | Examples (wt %) | | | | | | | | | | | | |
|---|---|---|---|---|---|---|---|---|---|---|---|---|---|
| Ingredient | CF9 | CF10 | CF11 | F5 | F6 | F7 | F8 | F9 | F10 | F11 | F12 | F13 | F14 |
| Propylene glycol | 23 | 23 | 23 | 23 | 23 | 23 | 23 | 23 | 23 | 23 | 23 | 23 | 23 |
| Dodecylbenzene sulfonic acid | 6.5 | 4.5 | 7.5 | 6.5 | 6.5 | 6.5 | 6.5 | 6.5 | 6.5 | 4.5 | 7.5 | 7.5 | 7.5 |
| Monoethanol amine | 25 | 15 | 30 | 25 | 25 | 25 | 25 | 25 | 25 | 15 | 30 | 30 | 30 |
| Oleic acid | 10 | 10 | 10 | 10 | 10 | 10 | 10 | 10 | 10 | 10 | 10 | 10 | 10 |
| Synthesis S2 | — | — | — | 25 | — | — | — | — | — | — | — | — | — |
| Synthesis S3 | — | — | — | — | 25 | — | — | — | — | — | — | — | — |
| Synthesis S4 | — | — | — | — | — | 25 | — | — | — | 37 | — | 19 | — |
| Synthesis S5 | — | — | — | — | — | — | 25 | — | — | — | — | — | — |
| Synthesis S6 | — | — | — | — | — | — | — | 25 | — | — | — | — | — |
| Synthesis S7 | — | — | — | — | — | — | — | — | — | — | 19 | — | — |
| Synthesis S9 | — | — | — | — | — | — | — | — | 25 | — | — | — | 19 |
| Synthesis S10 | 25 | 37 | 19 | — | — | — | — | — | — | — | — | — | — |
| Deionized water | 10.5 | 10.5 | 10.5 | 10.5 | 10.5 | 10.5 | 10.5 | 10.5 | 10.5 | 10.5 | 10.5 | 10.5 | 10.5 |
| Total wt % surfactants | 66.5 | 66.5 | 66.5 | 66.5 | 66.5 | 66.5 | 66.5 | 66.5 | 66.5 | 66.5 | 66.5 | 66.5 | 66.5 |
| % of surfactants -- nonionic | 37.6 | 55.6 | 28.6 | 37.6 | 37.6 | 37.6 | 37.6 | 37.6 | 37.6 | 55.6 | 28.6 | 28.6 | 28.6 |

TABLE 4

| | Examples (wt %) | | | | | | | | |
|---|---|---|---|---|---|---|---|---|---|
| Ingredient | CF11 | CF12 | F15 | F16 | F17 | F18 | F19 | F20 | F21 |
| Propylene glycol | 6 | 6 | 6 | 6 | 6 | 6 | 6 | 6 | 6 |
| Dodecylbenzene sulfonic acid | 18 | 18 | 18 | 18 | 18 | 18 | 18 | 18 | 18 |
| Monoethanol amine | 4.4 | 4.4 | 4.4 | 4.4 | 4.4 | 4.4 | 4.4 | 4.4 | 4.4 |
| Oleic acid | 5 | 5 | 5 | 5 | 5 | 5 | 5 | 5 | 5 |
| Synthesis S1 | — | — | — | — | — | — | — | 20 | — |
| Synthesis S2 | — | — | 20 | — | — | — | — | — | — |
| Synthesis S3 | — | — | — | 20 | — | — | — | — | — |
| Synthesis S4 | — | — | — | — | 20 | — | — | — | — |
| Synthesis S5 | — | — | — | — | — | 20 | — | — | — |
| Synthesis S6 | — | — | — | — | — | — | 20 | — | — |
| Synthesis S8 | 20 | — | — | — | — | — | — | — | — |
| Synthesis S9 | — | — | — | — | — | — | — | — | 20 |
| Synthesis S10 | — | 20 | — | — | — | — | — | — | — |
| Deionized water | 46.6 | 46.6 | 46.6 | 46.6 | 46.6 | 46.6 | 46.6 | 46.6 | 46.6 |
| Total wt % surfactants | 47.4 | 47.4 | 47.4 | 47.4 | 47.4 | 47.4 | 47.4 | 47.4 | 47.4 |
| % of surfactants -- nonionic | 42.2 | 42.2 | 42.2 | 42.2 | 42.2 | 42.2 | 42.2 | 42.2 | 42.2 |

### Low Temperature Detergency Stability

The low temperature detergency stability, LTDS, of the laundry detergent formulations of Comparative Examples CF1-CF13 and Examples F1-F21 was assessed in a Terg-o-tometer Model TOM-52-A available from SR Lab Instruments (6×1 L wells) agitated at 120 cycles per minute with the conditions noted in TABLE 5.

TABLE 5

| Parameter | Setting |
|---|---|
| Temperature 1 | 30° C. |
| Temperature 2 | 10° C. |
| Water hardness | 250 ppm, Ca²/Mg²⁺ = 2.04/1.67 |
| Fabric Types | JB003 Sebum Cloth |
| (3 in each well) | |
| Stains | Synthetic sebum, gum, pigment (from China |
| | Research Institute of Daily Chemical |
| | Industry) |
| Wash time | 20 minutes |
| Rinse time | 2 minutes |
| Liquid laundry detergent | 0.8 g/L |
| dosage | |

The soil removal index (SRI) was calculated using ASTM Method D4265-14. The low temperature detergency stability, LTDS, was determined for each of the laundry detergent formulations of Comparative Examples CF1-CF13 and Examples F1-F21 using the following formula:

$$LTDS = [ ( SRI ( T 2 ) ) / ( SRI ( T 1 ) ) ] \times 100 \%$$

wherein LTDS is the low temperature detergency stability in %, SRI(T2) is the soil removal index calculated using ASTM Method D4265-14 at temperature 2 (10° C.), and SRI(T1) is the soil removal index calculated using ASTM Method D4265-14 at temperature 1 (30° C.). The results are provided in TABLE 6.

TABLE 6

| Detergent Formulation | LTDS |
|---|---|
| Comp. Ex. CF1 | 74.8 |
| Comp. Ex. CF2 | 86.7 |
| Comp. Ex. CF3 | 93.0 |
| Comp. Ex. CF4 | 81.9 |
| Comp. Ex. CF5 | 85.5 |
| Comp. Ex. CF6 | 85.7 |
| Comp. Ex. CF7 | 87.3 |
| Comp. Ex. CF8 | 88.5 |
| Comp. Ex. CF9 | 89.4 |
| Comp. Ex. CF10 | 93.6 |
| Comp. Ex. CF11 | 91.7 |
| Comp. Ex. CF12 | 93.1 |
| Comp. Ex. CF13 | 91.7 |
| F1 | 98.0 |
| F2 | 101.8 |
| F3 | 109.3 |
| F4 | 116.1 |
| F5 | 108.5 |
| F6 | 104.0 |
| F7 | 102.0 |
| F8 | 108.7 |
| F9 | 97.9 |
| F10 | 101.3 |
| F11 | 101.3 |
| F12 | 99.5 |
| F13 | 101.6 |
| F14 | 106.6 |
| F15 | 109.3 |
| F16 | 99.8 |
| F17 | 119.4 |
| F18 | 110.2 |
| F19 | 119.8 |
| F20 | 113.7 |
| F21 | 114.9 |

We claim:

1. A method of formulating a laundry detergent formulation to have detergency stability for cleaning water temperatures ranging from 10 to 30° C., comprising:
(a) selecting an anionic surfactant, wherein the anionic surfactant is selected from the group consisting of alkyl sulfates, alkyl benzene sulfates, alkyl benzene sulfonic acids, alkyl benzene sulfonates, alkyl polyethoxy sulfates, paraffin sulfonic acids, paraffin sulfonates, olefin sulfonic acids, olefin sulfonates, alpha-sulfocarboxylates, esters of alpha-sulfocarboxylates, alkyl glyceryl ether sulfonic acids, alkyl glyceryl ether sulfonates, sulfates of fatty acids, sulfonates of fatty acids, sulfonates of fatty acid esters, alkyl phenol polyethoxy ether sulfates, 2-acryloxy-alkane-1-sulfonic acids, 2-acryloxy-alkane-1-sulfonates, beta-alkyloxy alkane sulfonic acids, beta-alkyloxy alkane sulfonates, oleic acid and mixtures thereof;
(b) selecting a nonionic surfactant, wherein the nonionic surfactant is selected from the group of nonionic surfactants having formula (i) 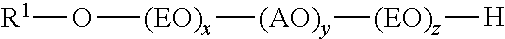
wherein R¹ is a linear C₈₋₁₈ alkyl group; wherein AO is an oxyalkylene group with 3 to 5 carbon atoms; wherein x is 2 to 4; wherein y is 6 to 25; wherein z is 1 to 50; and wherein the nonionic surfactant is selected based on its ability to impart detergency stability to the laundry detergent formulation for cleaning water temperatures ranging from 10 to 30° C.;
(c) selecting a water miscible organic solvent, wherein the water miscible organic solvent is selected from the group consisting of a C₁₋₄ alcohol with one hydroxyl group (e.g., ethanol); propylene glycol; glycerol; 1,3-butanediol; 1,3-hexanediol; dipropylene glycol and mixtures thereof; and
combining the selected anionic surfactant, the selected nonionic surfactant, the selected water miscible organic solvent and water to provide the formulated laundry detergent formulation.

2. The method of claim 1, wherein AO is an oxyalkylene group with 3 carbon atoms; wherein the formulated laundry detergent formulation comprises 5 to 95 wt %, based on weight of the formulated laundry detergent formulation, of the selected anionic surfactant (a) plus the selected nonionic surfactant (b).

3. The method of claim 2, wherein the selected nonionic surfactant (b) comprises 15 to 60 wt % of the combination of the selected anionic surfactant (a) plus the selected nonionic surfactant (b).

4. The method of claim 3, wherein the formulated laundry detergent formulation comprises 5 to 40 wt %, based on weight of the formulated laundry detergent formulation, of the water miscible organic solvent.

5. The method of claim 1, wherein AO is an oxyalkylene group with 3 carbon atoms; wherein the formulated laundry detergent formulation comprises 45 to 70 wt %, based on weight of the formulated laundry detergent formulation, of the selected anionic surfactant (a) plus the selected nonionic surfactant (b).

6. The method of claim 5, wherein the selected nonionic surfactant (b) comprises 15 to 60 wt % of the combination of the selected anionic surfactant (a) plus the selected nonionic surfactant (b).

7. The method of claim 6, wherein the formulated laundry detergent formulation comprises 20 to 40 wt %, based on weight of the formulated laundry detergent formulation, of the water miscible organic solvent.

8. The method of claim 1, wherein the formulated laundry detergent formulation further comprises an optional additive selected from the group consisting of builders; hydrotropes; foam control agents; enzymes; preservatives; fragrances; fluorescent whitening agents; bleach; dyes; additive polymers; fabric softeners; pH adjusters/buffers and mixtures thereof.

9. Use of a surfactant blend to impart low temperature detergency stability to a laundry detergent formulation, wherein the surfactant blend comprises:
(a) an anionic surfactant is selected from the group consisting of alkyl sulfates, alkyl benzene sulfates, alkyl benzene sulfonic acids, alkyl benzene sulfonates, alkyl polyethoxy sulfates, paraffin sulfonic acids, paraffin sulfonates, olefin sulfonic acids, olefin sulfonates, alpha-sulfocarboxylates, esters of alpha-sulfocarboxylates, alkyl glyceryl ether sulfonic acids, alkyl glyceryl ether sulfonates, sulfates of fatty acids, sulfonates of fatty acids, sulfonates of fatty acid esters, alkyl phenol polyethoxy ether sulfates, 2-acryloxy-alkane-1-sulfonic acids, 2-acryloxy-alkane-1-sulfonates, beta-alkyloxy alkane sulfonic acids, beta-alkyloxy alkane sulfonates, oleic acid and mixtures thereof; and
(b) a nonionic surfactant, wherein the nonionic surfactant is selected from the group of nonionic surfactants having formula (I) 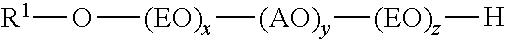
wherein R¹ is a linear C₈₋₁₈ alkyl group; wherein x is 2 to 4; wherein AO is an oxyalkylene group with 3 to 5 carbon atoms; wherein y is 6 to 25; wherein the low temperature detergency stability is exhibited across washing temperatures of 10 to 30° C.

10. A method of washing a fabric article, comprising:
providing a soiled fabric article;
formulating a laundry detergent formulation according to the method of claim 1;
providing a wash water; and
applying the wash water and the formulated laundry detergent formulation to the soiled fabric article to provide a cleaned fabric article; wherein the wash water is at a temperature of 10 to 30° C.
